(19) United States
(12) Patent Application Publication
(10) Pub. No.: US 2009/0266097 A1
(43) Pub. Date: Oct. 29, 2009

(54) MECHANISM FOR MAINTAINING A DESIRED TEMPERATURE IN A TRUCK CAB INCLUDING AN AUXILIARY MOTOR FOR OPERATING A VEHICLE AIR CONDITIONING PUMP AS WELL AS A SECONDARY GENERATOR FOR PROVIDING EITHER POWER WHEN THE VEHICLE IS PARKED OR A CONVECTIVE HEAT TRANSFER VIA A FLUID JACKET COMMUNICATING WITH A VEHICLE MOUNTED CONVECTIVE HEAT TRANSFER NETWORK

(76) Inventor: David Hamilton, Bear Lake, MI (US)

Correspondence Address: DOUGLAS S. BISHOP;BISHOP & HEINTZ, P.C., 440 WEST FRONT AT OAK, P.O. BOX 707, TRAVERSE CITY, MI, 49685-0707, US

(21) Appl. No.: 12/498,608

(22) Filed: Jul. 7, 2009

Related U.S. Application Data
(63) Continuation-in-part of application No. 11/985,090, filed on Nov. 14, 2007.

(51) Int. Cl. B60H 1/32; F04B 17/00; F25B 27/00

(52) U.S. Cl. 62/236; 417/321

(57) ABSTRACT

An assembly for providing either of auxiliary power and/or convective heating of an auxiliary exhaust, such as provided via a water jacket surrounding the engine exhaust interposed between an auxiliary generator and the truck tail pipe and circulated by a pump to provide heat to the cab interior. A further alternate variant provides for solar panels mounted to an exterior cab location and for operating the vehicle electric motor with or without the need for batteries. An associated articulating or pivoting mechanism is provided for displacing the solar panels from a first position in which it is stored against a rear surface of the cab, and to a second position in which is it arrayed upwardly above the cab.

### CROSS REFERENCE TO RELATED APPLICATIONS

The present application is a continuation-in-part of U.S. application Ser. No. 11/985,090, filed Nov. 14, 2007, and entitled Diesel Track Battery Disclosure.

### FIELD OF THE INVENTION

The present invention discloses a number of alternative assemblies for providing either air conditioning or heat to a truck cab interior and which utilizes an auxiliary power source additional to the main engine (such as diesel). Variants include the provision of a secondary AC, DC or hydraulic motor for operating an AC pump also connected to the main engine. Related variants include providing a secondary generator for providing auxiliary power to the vehicle AC as well as providing additional heat through a secondary water jacket associated with the generator and which operates in cooperation with a similar convective fluid network associated with the main motor. Yet additional variants include the provision of elevatable solar panels secured to the vehicle cab and communicating with photovoltaic cells and which serve to recharge the vehicle batteries.

### BACKGROUND OF THE INVENTION

The prior art is documented with various types of air conditioning and/or heating systems for use with land vehicles. Such assemblies typically incorporate a generator and battery arrangement in cooperation with a main source of propulsion, i.e., an engine, in order to such as provide for charging of the battery through the generator.

One such example is set forth in U.S. Pat. No. 6,874,330, to Iritani, and which teaches a unit for performing an air conditioning operation by electrical power supplied from a battery. Upon a residual charging degree of the battery becoming equal to or lower than a preset target degree, an electrical motor generator is driven by a vehicle engine so that the battery is charged through the electrical motor generator. Further, and upon a rotational speed of the engine being lower than a predetermined speed or when a power generation efficiency due to the engine is lower than a predetermined efficiency, air-conditioning capacity of the AC unit is set lower, so that a consumption power of the AC is restricted. In this fashion, the frequency is reduced for starting the engine for the sole purpose of charging the battery.

U.S. Patent Publication No. 2003/0141049, to Kennedy, teaches an auxiliary system for trucks and which includes a small diesel engine coupled to an air conditioner compressor and an automotive style DC alternator. During hot weather, the auxiliary engine rotates the AC compressor to provide cool air to the truck accessories, with load management controlling of alternator current output to provide DC power to accessories and for battery charging. Upon occurrence of a peak load condition, the voltage is reduced into the field of the alternator in a form of load management wherein the truck batteries act as a power sink and the alternator is used to replenish any power drawn from the truck batteries when the peak demand is removed. During cold weather the engine coolant is used to cool the auxiliary engine and is circulated through a heat exchanger for warming of the truck interior, the full capacity of the alternator being allowed to accommodate the higher amperage drawing typical of cold weather diesel operation.

U.S. Pat. No. 6,889,762, issued to Ziegler, discloses an AC system for use in an over-the-road or off-road vehicle and which provides for operation during both engine on and off conditions. The system utilizes a variable speed, motor driven compressor controlled by an intelligent power generation management controller and which selects from one of the available sources of power on the vehicle to drive the compressor and modulates the compressor speed and capacity based upon the operational parameters and source availability and depletion. The controller may also operate a coolant or air heater to provide heating to the interior compartments.

Finally, U.S. Pat. No. 5,125,236, issued to Clancey et al., teaches a combined generator set and air conditioning compressor drive system for use in a mobile vehicle. Components of the device include an auxiliary engine, a compressor, and a motor-generator. Upon the existence of an unavailability condition of an external source of energy, the motor-generator shaft is driven by the auxiliary engine and operated as a generator to provide electricity to the vehicle. The compressor is also shaft driven and, upon the external source of electricity again becoming available, the motor generator resumes operation of the motor to drive the compressor.

### SUMMARY OF THE INVENTION

The present invention discloses a number of alternative assemblies for providing either air conditioning or heat to a truck cab interior and which utilizes an auxiliary power source additional to the main engine (such as diesel). Variants include the provision of a secondary AC, DC or hydraulic motor for operating an AC pump which also connected to the main engine. Related variants include providing a secondary generator for providing auxiliary power to the vehicle AC as well as providing additional heat through a secondary water jacket associated with an exhaust portion of the secondary generator, this occurring separately or in combination with a similar convective fluid network associated with the main motor. Yet additional variants include the provision of elevatable solar panels secured to the vehicle cab and communicating with photovoltaic cells and which serve to recharge the vehicle batteries.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a general illustration of a first variant and which includes an air conditioning pump included in a networked arrangement with a main motor operated in a shut off condition by a DC electric motor, the AC pump further including an end mounted and linearly displaceable magnetic pulley plate connected to a selectively driving or free-wheeling end plate associated with the DC motor, the latter permitting the DC motor to remain both connected to and deactivated from the AC pump during primary operation of the AC pump by the main vehicle motor;

FIG. 2 is a perspective view of a related sub-variant substituting a hydraulic motor for the DC electric motor of FIG. 1;

FIG. 3 is a perspective view of another related sub-variant incorporating an AC electric motor;

FIG. 3A is a perspective view of a further related sub-variant incorporating an internal combustion motor for any of the AC, DC or hydraulic motors;

FIG. 4 is an illustration of an auxiliary power generator secured to a remote location of the vehicle frame and communicating, via a multi-switch arrangement, with an electrical architecture associated with the vehicle and for switching power from a main truck battery to the auxiliary generator, such as when the main engine is deactivated;

FIG. 5 is an illustration similar to that shown in FIG. 1 and illustrating a modified variant in which a secondary clutch is incorporated between the AC pump and vehicle cooling fan in order to operate the fan during auxiliary powering of the AC pump by the secondary motor;

FIG. 6 is a sectional view of a secondary generator according to a further variant and further showing the feature of a heat recovery water jacket encasing an exhaust pipe of the generator, the heated water subsequently passing through a heat exchanger for introduction into the truck cab interior;

FIG. 7 is an illustration similar to that shown in FIG. 4 and incorporating an auxiliary generator with heat recovery jacket for providing a dedicated heat source to a rear cab compartment;

FIG. 7A is an illustration similar to that shown in FIG. 7 in which the auxiliary generator with heat recovery jacket forms a part of a heat recovery fluid network also including the main vehicle motor; and

FIG. 8 is another alternate illustration in which a solar panel is mounted to an exterior cab location and for operating the vehicle electric motor with or without the need for batteries, associated articulating or pivoting mechanism being provided for displacing the solar panels from a first position retracted and hidden position to a second position in which the solar panel is arrayed upwardly from the roof of the cab, FIG. 8 also illustrating a more compact version of the auxiliary generator with built in heat exchanger technology incorporated atop a main vehicle engine.

### DETAILED DESCRIPTION OF THE PREFERRED EMBODIMENTS

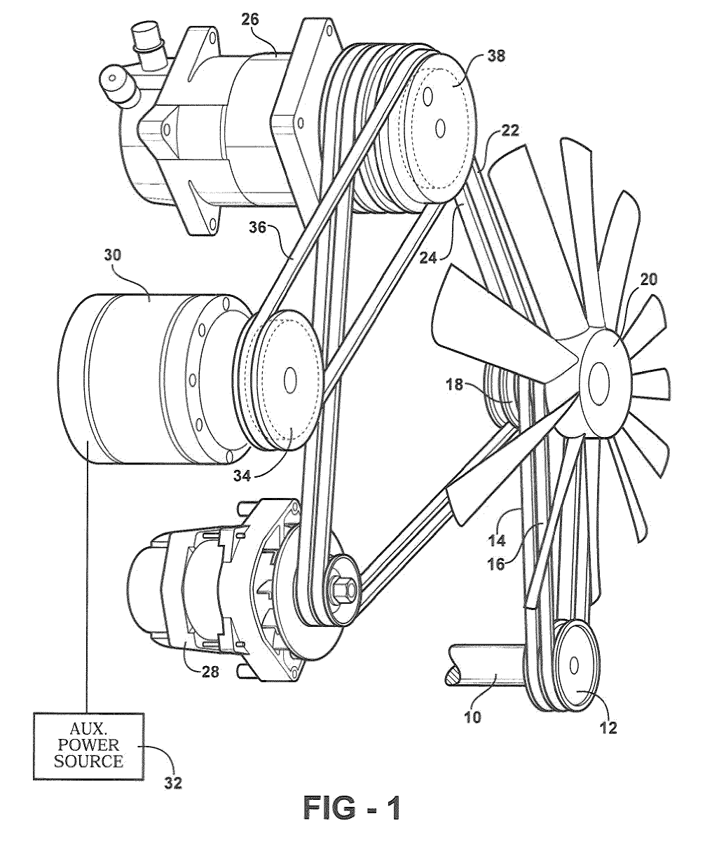

Referring now to FIG. 1 a general illustration is shown of a first variant and which includes an air conditioning pump which is operable when the main diesel engine is inactive. A main engine (not shown but which includes such as a diesel motor) drives a shaft 10 to which is attached a double belted wheel 12. Associated belts 14 and 16 extend from the wheel 12 and received at opposite ends within like seating locations of a rotating hub 18 associated with a multi-bladed fan 20.

In a primary operating arrangement, the driving rotation of the hub 18 (via the main motor output shaft 10) is transferred via a pair of belts 22 and 24 supported in a generally triangular shaped and supporting fashion about both an air conditioning pump 26 and a separate battery charging alternator 28. In this arrangement, an output force of the main motor (not shown) is transferred via the belts 22 and 24 to the AC pump 26, while at the same time recharging the batteries through the alternator 28.

When it is desired to operate the AC pump when the main motor is shut off, a separate DC electric motor 30 is provided and which is operated off of an auxiliary power source 32 (this including any of a separate generator, a separate battery bank, or a main battery). The DC motor 30 includes a uniquely designed (hidden) rotating clutch 34 which supports one end of a belt 36 also engaging an end-mounted magnetic induced plate 38 (see hidden lines in phantom in each of FIGS. 1-3A and 5) associated with the AC pump 26.

The design of the DC motor rotating clutch 34 is such that it can be deactivated during primary engine operation and in order to prevent turning of the DC motor. The clutch 34 is further designed such that it incorporates a magnetic inducing component to power the AC pump 26, again via the magnetic induced plate 38 which is illustrated in phantom and, when activated in the auxiliary operating mode, rotates the plate 38 to thereby operate the AC pump 26 without concurrently operating the belts 22 and 24 associated with the main operating protocol.

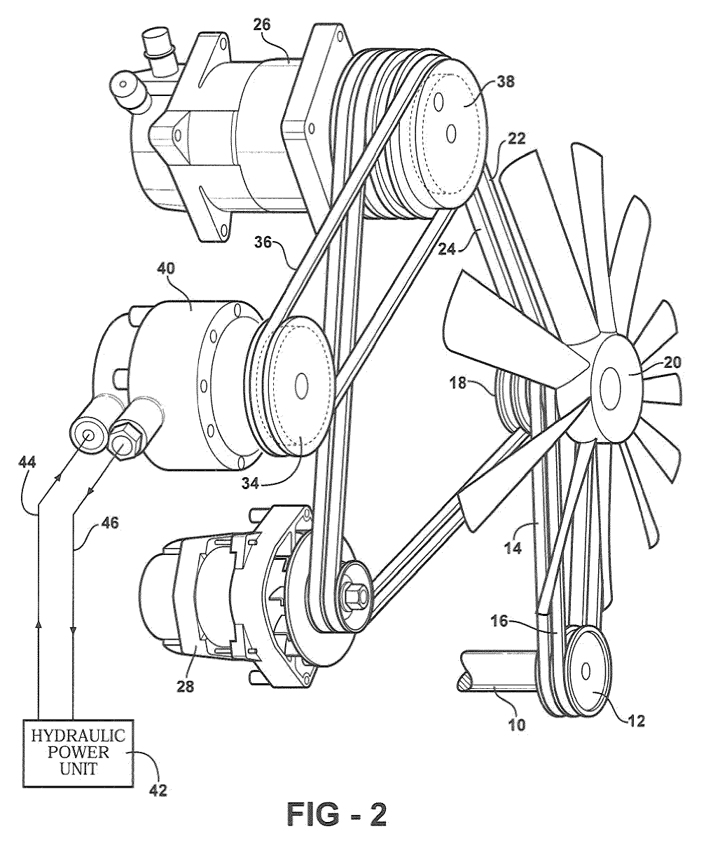

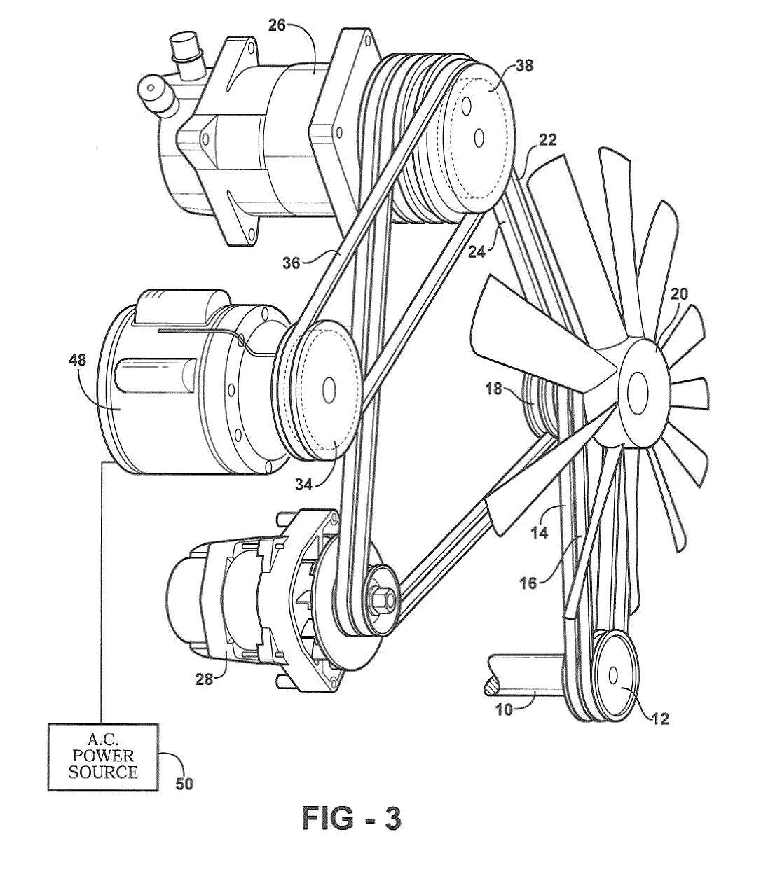

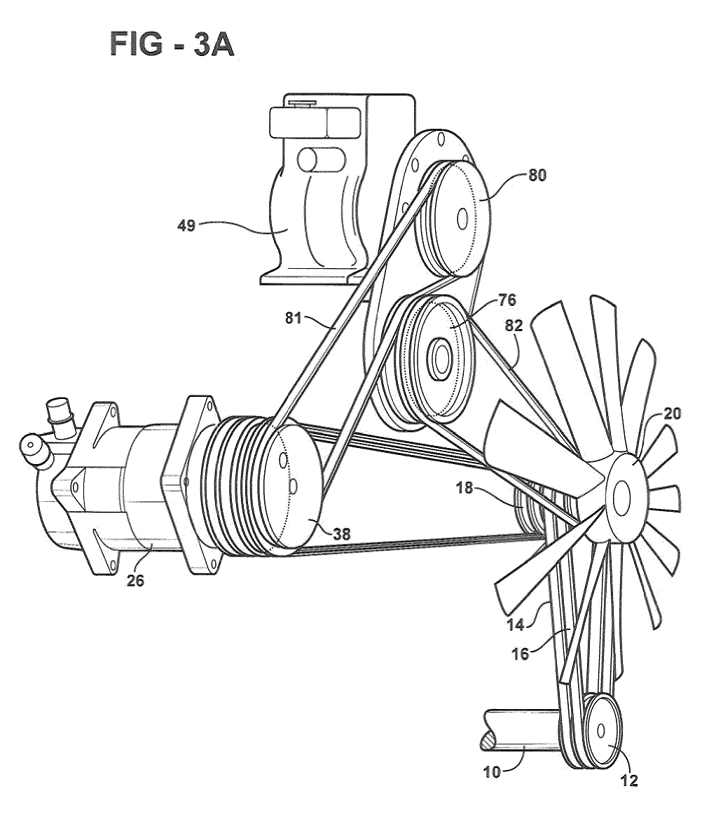

FIG. 2 is a perspective view of a related sub-variant substituting a hydraulic motor 40 for the DC electric motor of FIG. 1 and which further illustrates a hydraulic power unit 42 provided as the auxiliary power source and providing, via inlet line 44 and outlet line 46, a continuous flow of fluid to the hydraulic pump 40 for operating the AC pump in the auxiliary mode. FIG. 3 is a perspective view of another related sub-variant incorporating an AC electric motor 48 and associated power source 50 in substitution for either the DC motor 30 in FIG. 1 or the hydraulic motor 40 in FIG. 2. FIG. 3A is a perspective view of a further related sub-variant incorporating an internal combustion motor, at 49, for any of the AC, DC or hydraulic motors and for directly powering the AC pump 26 (with or without provision of a separate alternator 28).

It is noted that the secondary motors 30, 40, 48 and 49 shown in the variants of FIGS. 1-3 are typically mounted upon the main vehicle motor, although the invention is not limited to this arrangement.

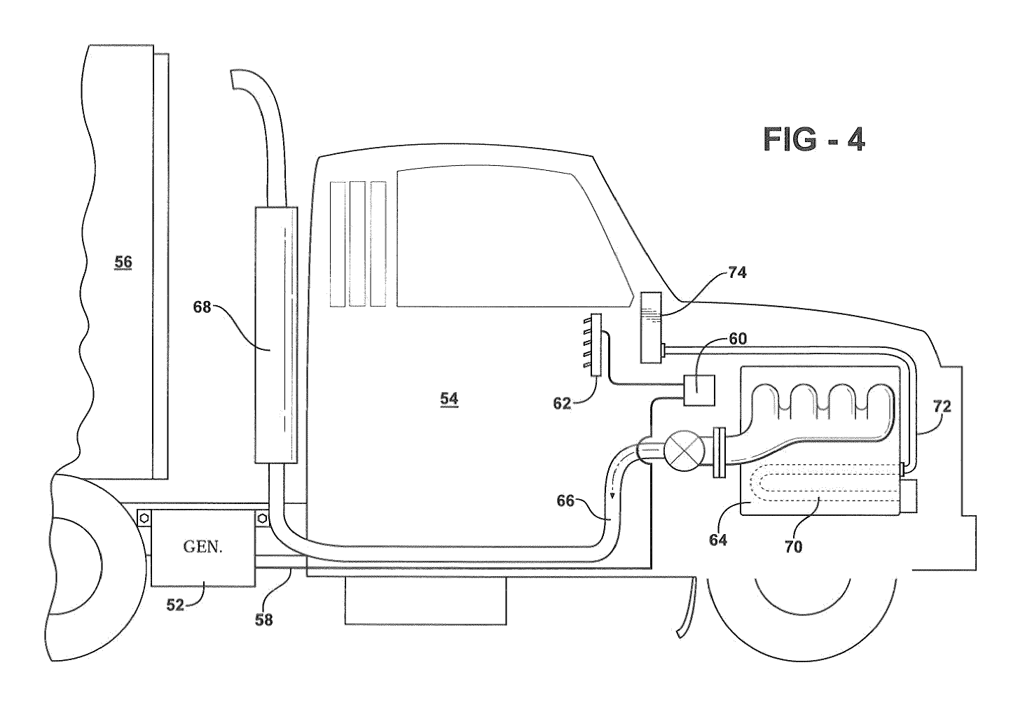

Referring now to FIG. 4, an illustration is shown of an auxiliary power generator 52 secured to a remote location of the vehicle frame and communicating, via a multi-switch arrangement, with an electrical architecture associated with the vehicle and for switching power from a main truck battery to the auxiliary generator, such as when the main engine is deactivated. In particular, the generator 52 (including either AC or DC operated motors) is typically bolted or otherwise secured to a rear location of the vehicle frame, such as between cab 54 and trailer 56 portions. Control lines 58 extend from the generator 52, along the frame and in a direction towards the front of the vehicle, under the hood and forward of the firewall and to connect to a solenoid control bank component 60.

A separate switch bank 62 (including up to five switches) is separately connected to the solenoid component 60. Other features include a main motor (e.g. diesel) 64, from which a rear exhaust 66 is vented through an exhaust pipe incorporating such as a catalytic converter (not shown) and prior to discharge through an upwardly extending tail pipe 68. A separate fluid jacket extending within the main motor 64 feeds a separate conduit 72 for providing engine heat for distributing through a register 74 associated with the forward vehicle cab interior.

The main truck battery (not shown) is utilized to power the switches 62 to in turn actuate the solenoid bank 60, which in turn triggers the operation of the separate electric motor incorporated into the generator 52. The switches 62 each define two way switches and are accessibly located such as upon the vehicle dashboard.

The first switch is triggered to selectively activate or deactivate (ON/OFF) each of the main electrical system or the solenoid bank 60. The second switch operates additional high or low switches (not shown) incorporated into the existing vehicle air conditioning system, which operates or drives the clutch associated with the electric motor to enable the motor to work in the auxiliary mode). The third switch activates the auxiliary system without necessitating the insertion of the key into the vehicle ignition. The fourth switch activates the normal AC switches (e.g. fan) to work with the auxiliary action of switches 2 and 3, and in particular directs the normal AC output architecture associated with main motor operation to work in the auxiliary powered mode. Finally, the fifth switch separately operates the generator system.

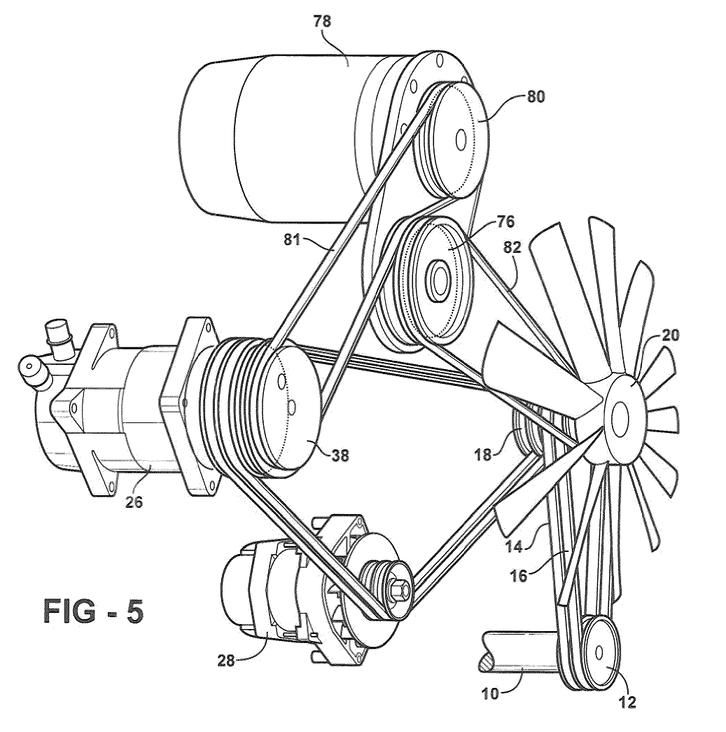

Referring now to FIG. 5, an illustration similar to that shown in FIG. 1 illustrates a modified variant in which a secondary clutch 76 is incorporated between a relocation of the AC pump 26 and vehicle cooling fan 20 in order to operate the fan during auxiliary powering of the air conditioning pump 26 by a reconfigured secondary (AC) electric motor 78. An additional clutch arrangement 80, similar to that shown at 38, is also provided and includes a belt 81 connected to clutch 38 on the AC unit 26. A separate belt 82 interconnects the clutch 76 with a forward-most location of the hub 18 associated with multi-bladed fan 20. The pulley 81 screws directly onto a shaft associated with the operation of the AC pump 26.

The purpose for the secondary clutch 76 and belt 82 is to enable the fan 20 to continue to turn during operation in the auxiliary mode, this maintaining the desired cooling effect for both the motor 78 and air conditioning pump 26. Otherwise, the fan would normally be in a freewheeling mode when the main motor (via output shaft 10) is deactivated. In certain applications, a switch (not shown) is provided for disengaging a clutch associated with the fan 20, and further so that the fan is permitted to operate in the auxiliary mode. Magnetic plates are again shown in phantom corresponding to the clutch arrangements at 76 and 80 and which operate to drive both the belt 81 for the air conditioning pump 26 as well as the belt 82 operating the fan 20.

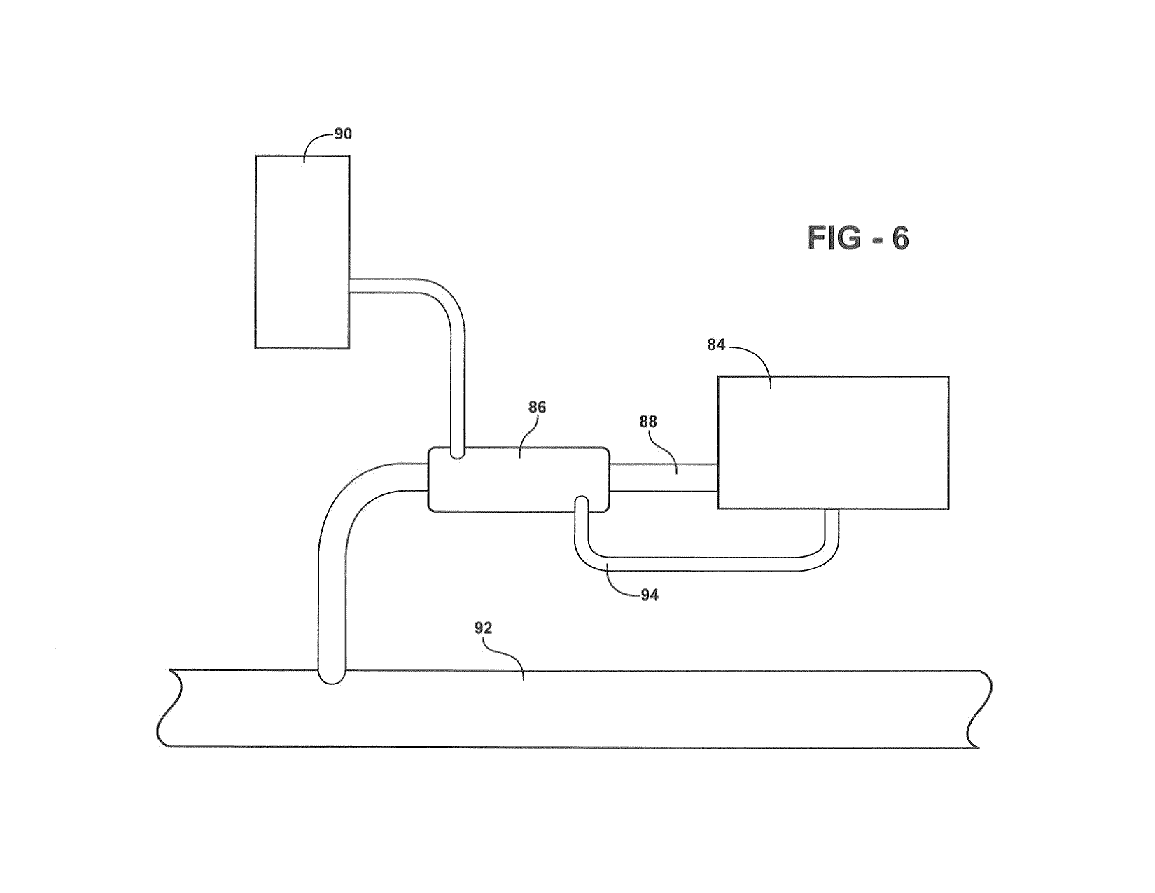

FIG. 6 is a sectional view of a secondary generator 84 according to a further variant and further showing, in general schematic fashion, the feature of a heat recovery water jacket 86 encasing an exhaust pipe 88 of the generator 84 (this further including any of an AC, DC or other motor). Heat transferred from the exhaust to the fluid jacket 86 is subsequently communicated through an appropriate heat exchanger 90 for introduction into the truck cab interior while the exhaust from pipe 88 proceeds to the main truck exhaust pipe, shown at 92.

In order to maximize heat exchange, a redirect line is further shown at 94 and which extends from the water jacket 86 to a surrounding location associated with the generator 84. The water jacket 86 is further typically sized and located, beyond what is shown, so that it can extend from a communicating location of the generator 84, thereby maximizing the heat transfer aspects of the design.

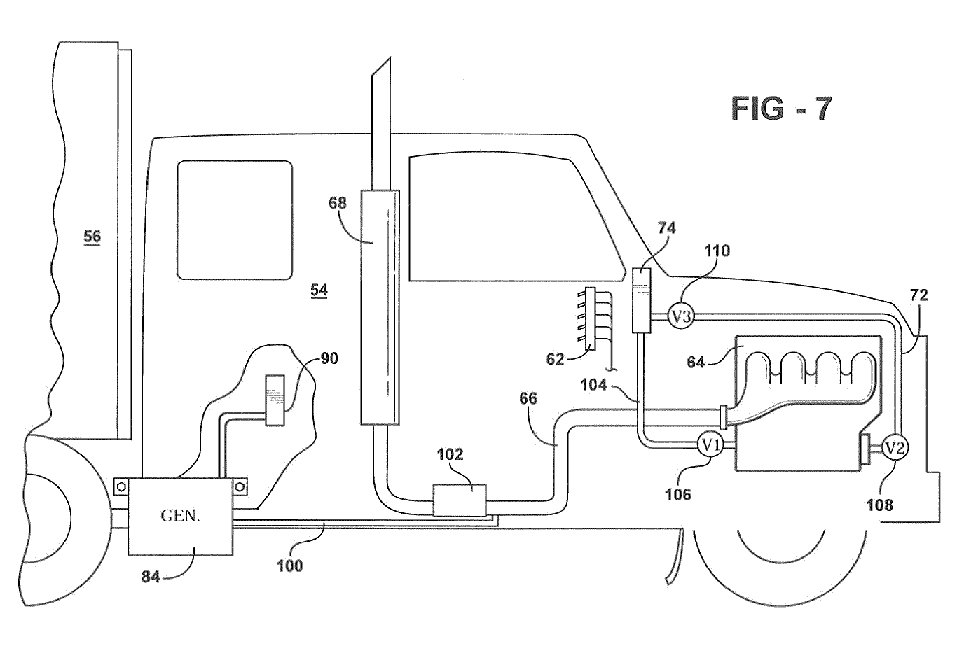

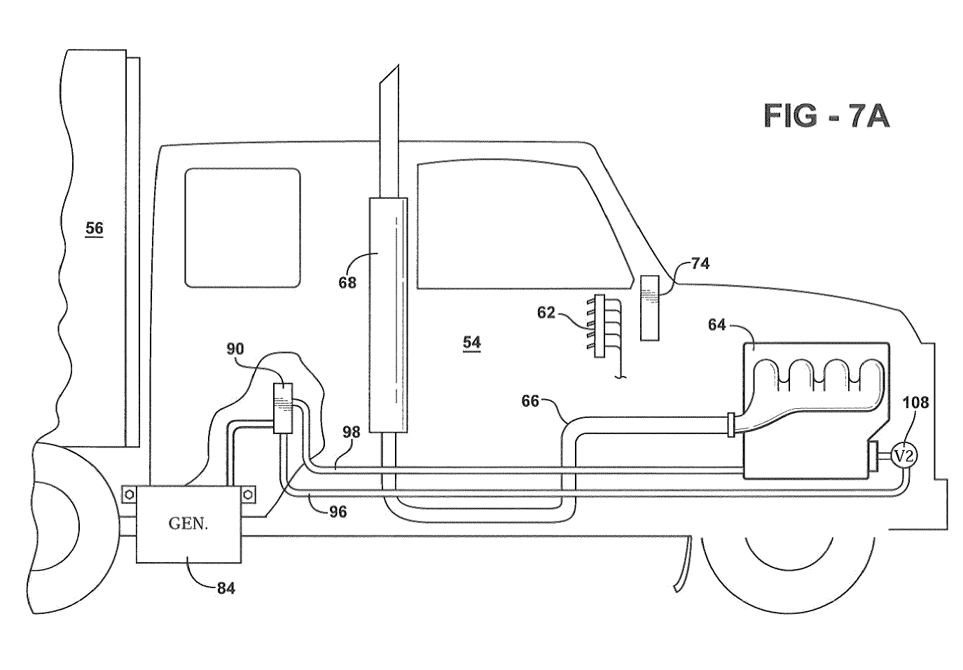

Referring now to FIG. 7, an illustration similar to that shown in FIG. 4 is provided and incorporating an auxiliary generator 94 with heat recovery jacket for providing a dedicated heat source to a rear cab compartment. As cooperatively viewed with the FIG. 7A (these being collectively provided to explain the functioning aspects of the design), the generator shown at 84 in FIG. 6 is again presented and forms a part of a heat recovery fluid network associated with the main engine compartment see again exchanger 90 which is located such as in a rear sleeping compartment associated with the vehicle truck cab 54.

Fluid lines 96 and 98 (see FIG. 7 A) extend from the rear located generator 84 to the forward located motor 64. As further shown in FIG. 7, the exhaust from the auxiliary generator 84 is channeled through line 100 for redelivery to the main engine exhaust line previously identified at 66 and at a location upstream from the vehicles catalytic converter representatively shown at 102.

As also shown in FIG. 7, a fluid heat exchange network associated with the main motor 64 includes again supply line 72 communicating with the forward located heat exchanger 74, as well as a further return line 104. An associated three way valve arrangement is provided and includes first valve 106 located at an inlet end of the line 104 leading to the motor block 64, a second valve 108 at an outlet location of the block 64 to fluid line 72 and a third valve 110 located at an inlet position relative to the forward heat exchanger 74. The first valve 106 is activated during normal operation in which heating or cooling exchange is provided only through the main motor 64. The second valve 108 closes off fluid flow from the main motor 64 when the system is operating solely off of auxiliary heat conversion (see again FIG. 7A with auxiliary fluid lines 96 and 98). The third valve 110 is provided in a summer auxiliary mode and in order to shut off heat to the forward register 74 in the cab (or the rear register 90 associated with the sleeper portion), with instead the heat being sink dissipated through the main block 64.

In this fashion the main and auxiliary heat exchangers can share a common fluid medium, and which can be replenished from time to time. The auxiliary mode is capable of being operated during vehicle down time, and in order to provide heat to either or both the forward or rear heat exchangers and which is recycled from the power generation occurring at the auxiliary generator 84 (see also electrical generating operation identified at 52 in FIG. 4).

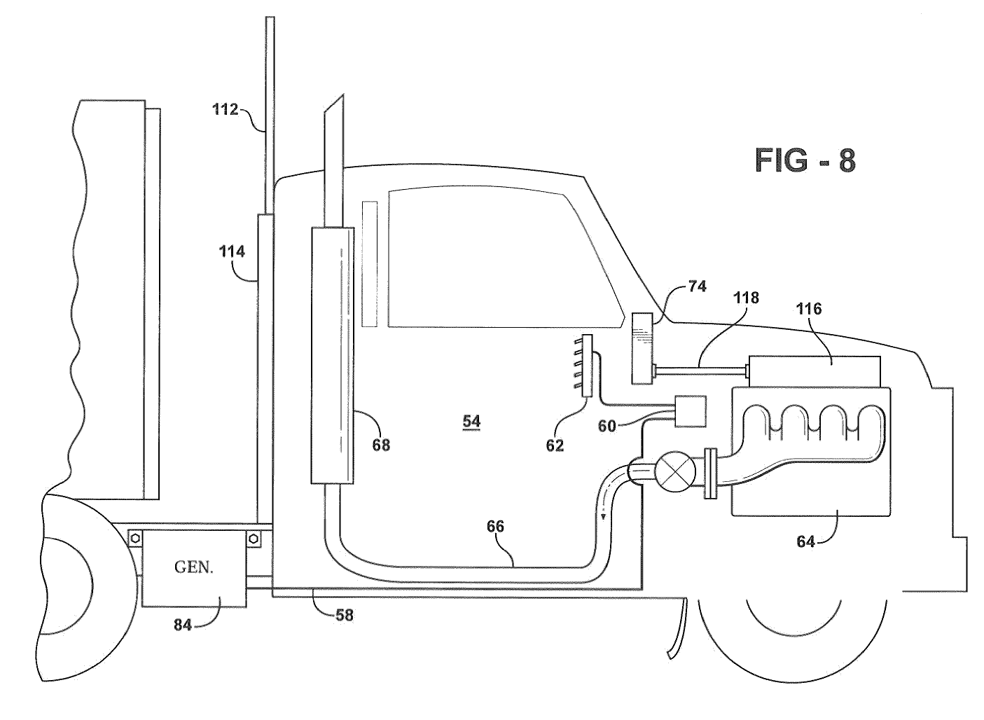

Finally, and referring to FIG. 8, another alternate illustration is provided in which a solar panel 112 is mounted to an exterior cab location (see also vertically extending and supporting housing 114) and for operating the vehicle electric motor with or without the need for batteries. An associated articulating or pivoting mechanism, such as primarily an elevating mechanism, is provided for displacing the solar panel(s) 112 from a first position retracted and hidden position within the rear cab surface mounted housing 114 to a second position in which the solar panel 112 is arrayed upwardly from the roof of the cab in elevated fashion.

Although not shown, an associated photovoltaic conversion assembly is incorporated into the interface established between the solar panel 112 and either the main vehicle battery or one or more secondary batteries associated with the auxiliary generator 84. Also shown in FIG. 8 is a more compact version of auxiliary generator, see as representatively depicted as 116, such as including both power generating and built in heat exchanger technology incorporated atop the main vehicle engine block 64. The auxiliary generator 116 communicates, via a modified conduit 118, with the forward cab located heat exchanger 74.

Having described my invention, other and additional preferred embodiments will become apparent to those skilled in the art to which it pertains, and without deviating from the scope of the appended claims. Specifically it is also understood that the auxiliary motor can also be provided gas and diesel, as well as AC/DC electric motors or hydraulic.

I claim:

1. An auxiliary power system incorporated into a vehicle architecture, the vehicle including a main motor driving a fan, an air conditioning pump and an alternator via a plurality of belts, said auxiliary power system comprising:
an auxiliary generator comprising at least a secondary motor connected to the air conditioning pump via a further belt; and
said secondary motor further including a rotating clutch which supports one end of said dedicated belt, an opposite end of which engaging an end-mounted magnetic induced plate associated with the air conditioning pump, said clutch incorporating a magnetic inducing component to power the air conditioning pump through said magnetic induced plate and, when activated in an auxiliary operating mode, rotating said plate to operate the air conditioning pump without concurrently operating the one or more belts associated with the main motor, pump and alternator.

2. The system as described in claim 1, further comprising an auxiliary power source feeding said secondary motor such that, upon deactivation of the main motor, the air conditioning pump is activated to provide cooling air to a vehicle cab interior.

3. The system as described in claim 1, said secondary motor further comprising any of an AC electric motor, a DC electric motor, an internal combustion gas motor, a diesel motor or hydraulic motor.

4. The system as described in claim 1, further comprising a secondary clutch operating a further belt incorporated between the air conditioning pump and the fan in order to operate the fan during auxiliary powering of the air conditioning pump by the secondary motor.

5. The system as described in claim 1, further comprising control lines extending from said secondary motor along a vehicle frame and in a direction towards a front of the vehicle to connect to a solenoid control bank component incorporated into the main vehicle architecture.

6. The system as described in claim 5, further comprising a switch bank accessible from a vehicle interior and connected to said solenoid control bank and, upon being powered, triggers actuation of said solenoid bank to in turn trigger operation of the secondary motor.

7. The system as described in claim 6, said switches each defining two way switches and which are accessibly located upon a vehicle dashboard.

8. The system as described in claim 7, further comprising a first switch triggered to selectively activate or deactivate (ON/OFF) each of a main electrical system associated with the vehicle architecture or said solenoid bank.

9. The system as described in claim 8, further comprising a second switch triggered to operate additional high or low switches incorporated into the existing vehicle air conditioning system and for operating said clutch associated with the secondary motor.

10. The system as described in claim 9, further comprising a third switch activating said auxiliary generator without necessitating insertion of a key into a vehicle ignition.

11. The system as described in claim 10, further comprising a fourth switch activating air conditioning switches associated with the main electrical system in order to work with said second and third switches, and in particular to direct the air conditioning output architecture associated with main motor operation to work in the auxiliary powered mode.

12. The system as described in claim 11, further comprising a fifth switch separately operates said auxiliary generator.

13. The system as described in claim 1, further comprising a heat recovery fluid jacket surrounding an exhaust portion associated with said auxiliary generator and communicating with a downstream located heat exchanger associated with the vehicle.

14. The system as described in claim 13, further comprising fluid lines extending from a rear located auxiliary generator to a forward located main motor, an exhaust from said auxiliary generator being channeled through a line for delivery to a main engine exhaust line at a location upstream from a vehicles catalytic converter.

15. The system as described in claim 14, further comprising a fluid heat exchange network associated with a jacket surrounding the main motor and communicating with said fluid lines extending from said auxiliary generator, said fluid exchange network including a supply line communicating with a forward located heat exchanger, a further return line extending from said forward heat exchanger to the motor.

16. The system as described in claim 15, further comprising a three way valve arrangement including first valve located at an inlet end of said return line leading to the main motor, a second valve at an outlet location of the main motor to said supply line, and a third valve located at an inlet position relative to the forward heat exchanger, such that said first valve is activated during normal operation in which heating or cooling exchange is provided only through the main motor, said second valve is closed to interrupt fluid flow from the main motor when the system is operating solely off of auxiliary heat conversion, and said third valve is closed during warm weather periods to shut off heat to said heat register and to cause heated fluid to be dissipated (sinked) through the main block 64.

17. The system as described in claim 1, further comprising a solar panel mounted to an exterior cab location for operating the secondary motor.

18. The system as described in claim 17, further comprising an elevating mechanism is provided for displacing said solar panel from a first position retracted and hidden position within a rear cab surface mounted housing to a second position in which said solar panel is arrayed upwardly from a roof of the cab in elevated fashion.

19. The system as described in claim 17, further comprising an associated photovoltaic conversion assembly incorporated into an interface established between said solar panel and a battery associated with said auxiliary generator.
